(19) United States
(12) Patent Application Publication
(10) Pub. No.: US 2025/0057186 A1
(43) Pub. Date: Feb. 20, 2025

(54) EXTRUDED FOOD PIECES HAVING A ROUGH TEXTURED SURFACE AND METHODS OF MAKING

(71) Applicant: General Mills, Inc., Minneapolis, MN (US)

(72) Inventors: Goeran WALTHER, Plymouth, MN (US); Azad EMIN, Karlsruhe (DE); Patrick WITTEK, Stuttgart (DE)

(73) Assignee: General Mills, Inc., Minneapolis, MN (US)

(21) Appl. No.: 18/726,166

(22) PCT Filed: Jan. 5, 2022
(86) PCT No.: PCT/US2022/011220

§ 371 Date: Jul. 2, 2024

(51) Int. Cl. A23J 3/26; A23J 3/14; A23J 3/16; A23K 10/30; A23K 20/147; A23K 40/25

(52) U.S. Cl. CPC A23J 3/26; A23J 3/14; A23J 3/16; A23K 10/30; A23K 20/147; A23K 40/25

(57) ABSTRACT

The present disclosure relates to extruded protein products and methods for producing an extruded protein product. In particular, an extruded piece is disclosed having a high protein content that includes canola protein, and having a rough exterior appearance. Methods for making an extruded piece include processing, under extrusion conditions, a composition that includes a combination of a protein that includes canola protein, a structural ingredient, water, and an oil, and extruding through an extruder die assembly that exposes the composition to irregular flow prior to exiting the die assembly.

### TECHNOLOGY

The present disclosure generally relates to an extruded protein product and methods of making such a product.

### BACKGROUND

High protein food products have found popularity among consumers as a way to eat nutritionally dense foods. Consumers want diverse ways to get increased protein into their diets. Thus, there is a need for new high protein food products to satisfy the increasing consumer desire for protein.

### SUMMARY

Provided herein is a composition including extruded pieces.

A method of making extruded food pieces having a rough textured surface is provided herein. The method includes processing a composition under extrusion conditions to produce a processed mass, forming the extruded food pieces from the processed mass using an extruder die assembly that exposes the processed mass to irregular flow prior to exiting one or more openings in the extruder die assembly. In some embodiments, the composition can have a protein content of about 10% to about 65% by weight of the composition, the protein content including canola protein in an amount of at least 10% by dry weight of the protein content, a structural component in an amount of from about 5% to about 40%, a moisture content of from about 25% to about 65% by weight, and an oil content of from about 1% to about 15% by weight.

In some embodiments of a method of making extruded food pieces, the canola protein can comprise at least 25%, or at least 95% by dry weight of the protein content.

In some embodiments of a method of making extruded food pieces, extrusion conditions can include a specific flow rate of the processed mass from the die assembly, where the specific flow rate can range from about 1 to about 5 kg per hour per mm2.

In some embodiments of a method of making extruded food pieces, each of the one or more openings can have area of from about 3 mm2 to about 80 mm2.

In some embodiments of a method of making extruded food pieces, the extruded food pieces can have a specific density of 0.5 g/cc to about 1.0 g/cc.

Some embodiments of a method of making extruded food pieces can include a step of drying the extruded food pieces to a moisture content of 1-8% to produce dried food pieces. In some embodiments, dried food pieces can have a specific density of about 0.5 g/cc to 1 g/cc.

Also provided herein are food compositions comprising extruded food pieces made according to any method described herein. The food composition is formulated for human or animal (e.g., companion animal) consumption.

In some embodiments, a food composition can be stable at a temperature at or below 10° C. for at least 1 month. In some embodiments, a food composition can be stable at room temperature for at least 6 months.

Also provided herein are extruded food pieces, and food products containing such extruded food pieces. Extruded food pieces provided herein can include a protein content of about 12% to about 90% by dry weight of the extruded food pieces, where the protein content includes canola protein in an amount of at least 10% by dry weight of the protein content; a structural component in an amount of about 6% to about 75% by dry weight of the extruded food pieces, an oil content of about 1% to about 30% by dry weight of the extruded food pieces; and a rough textured surface. Extruded food pieces can be formulated for human or animal (e.g., companion animal) consumption.

In some embodiments of extruded food pieces provided herein, the canola protein can comprise at least 25%, or at least 95%, by dry weight of the protein content.

Also provided herein are packaged food products comprising extruded food pieces disclosed herein. A packaged food product can contain extruded food pieces made according to any method provided herein.

These and various other features and advantages will be apparent from a reading of the following detailed description.

### BRIEF DESCRIPTION OF THE DRAWINGS

FIG. 1 is a photograph of an extruded product containing soybean protein exhibiting a rough surface texture (left) and an extruded product containing oat protein exhibiting a smooth surface (right).

FIG. 2 shows photographs of two embodiments of an inventive extruded product containing canola protein exhibiting a rough surface texture.

### DETAILED DESCRIPTION

Extrusion technology has begun to produce protein products that have an enjoyable texture, while reducing or eliminating the use of animal protein. Many of these products are designed to mimic whole or ground meat and are meant to be eaten in place of meat. However, consumers expect an even greater variety of high protein foods that are suitable for different eating occasions. In addition, many consumers prefer to avoid certain protein sources, such as animal products. More recently, some consumers have preferred to avoid soybean-based protein due, at least in part, to naturally-occurring phytoestrogen content. As described herein, a new protein product has been produced having a high protein content that reduces or eliminates the use of animal-and soybean-based proteins, while achieving a good eating texture and visual interest from a rough surface texture. At least a portion of the protein content of a product provided herein is canola protein.

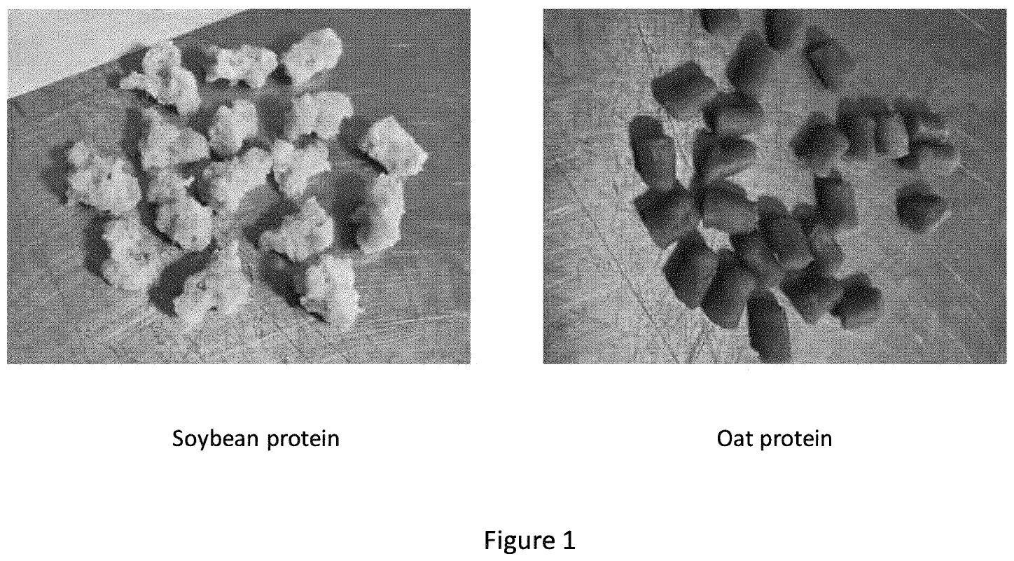

High protein extruded food products, such as those described in WO 2016/118479, can be made to be suitable for eating as a shelf stable product, such as a breakfast cereal, or as a wet or rehydrated product, such as a meat analog. Surprisingly, however, while researching protein sources that can be used to replace soybean protein for making high protein extruded food products, it was discovered that soybean protein alternatives, such as several commercially available pea proteins and a commercially available oat protein could not produce a rough surface texture that provides a natural-looking appearance that can be preferred over a smooth surface in some products. See, FIG. 1, comparing extruded pieces containing a soybean protein with a rough textured surface (left) with extruded pieces containing oat protein (right) that exhibit a smooth surface.

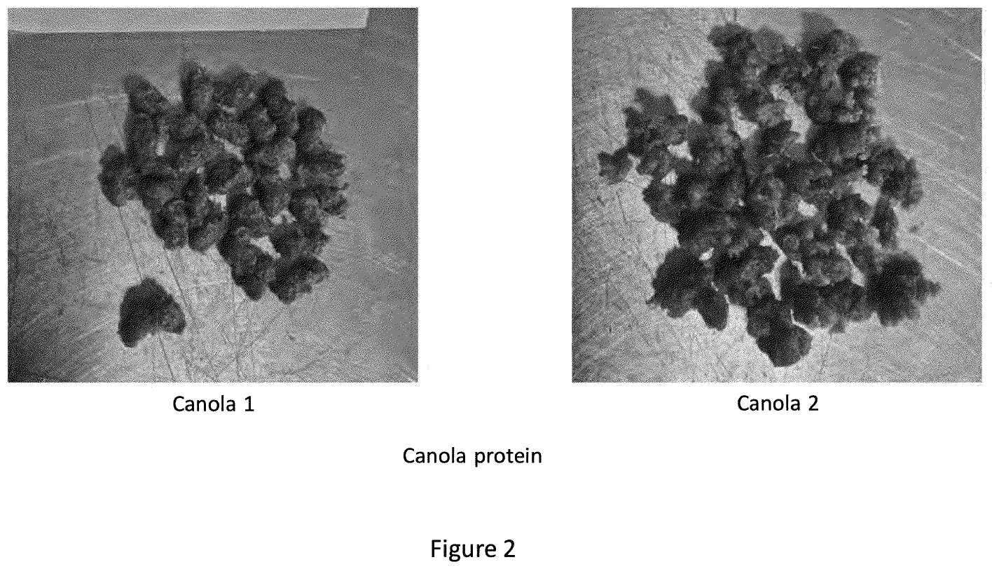

Unexpectedly, it was discovered that canola protein can be used to produce high protein extruded food products that have a desirable rough surface. See, FIG. 2. It was observed that when a composition containing canola protein, a structural ingredient, water, and oil was processed under extrusion conditions to form a processed mass, and formed using an extruder die assembly that exposes the processed mass to irregular flow prior to exiting the extruder die assembly, the processed mass exhibited irregular expansion upon exiting the die assembly that was not observed with other tested proteins. Without being bound by theory, it is believed that the observed irregular expansion when extruding compositions that contain canola protein produces a desired rough textured surface.

As used herein, the term “rough textured” refers to a surface that is irregular or rough rather than smooth. A rough textured surface can be visually apparent, as shown in FIG. 2, as compared to a smooth texture as shown in the right hand image of FIG. 1.

As used herein, an extruder die assembly that exposes a processed mass to irregular flow can include a die assembly that exposes the processed mass to small, large or multiple variations in die assembly cross section diameter or shape after exiting an extruder and entering the die assembly, and prior to an opening in the die assembly. It is to be understood that such a die assembly can include a single piece, or multiple pieces that are fit together, such as one or more transition apparatus (e.g., adapter plate, transition plate, and/or flow distribution plate) between an extruder and a die face plate, to achieve irregular flow. In some embodiments, a suitable extruder die assembly can have one or more openings, where each opening having a bore hole that has a land length of constant diameter that is less than 4× (e.g., less than 2×, less than 1×, or between about 0.2× and 0.5×) the diameter of the die opening. It is to be understood that a diameter of a die opening or bore hole refers to the average width of the opening or bore hole, and does not suggest that a die opening or bore hole is limited to a circular geometry. In some embodiments, each opening in a die assembly can have a diameter of from about 2 mm to about 10 mm (e.g., about 5 mm to about 10 mm).

A method of making extruded food pieces having a rough textured surface is provided herein. The method generally includes processing a composition that contains canola protein under extrusion conditions to produce a processed mass, and forming extruded pieces from the processed mass using an extruder die assembly that exposes the processed mass to irregular flow prior to exiting the extruder die assembly.

A composition suitable for extrusion in a method provided herein includes a protein content of about 10% to about 65% (e.g., about 20% to about 50%, or about 30% to about 45%) by weight of the composition. At least 10% (e.g., at least 25%, at least 30%, at least 45%, at least 95%, or up to 100%) by dry weight of the protein content in a composition is canola protein. Any suitable canola protein source, such as a canola protein concentrate (e.g., with a protein content of at least 70%) or a canola protein isolate (e.g., with a protein content of at least 80%, or at least 90%), can be used to supply canola protein content in a composition.

In some embodiments, a composition suitable for extrusion in a method provided herein can include a non-canola protein. For example, in embodiments where an extruded food is desired to have reduced soybean protein content rather than no soybean content, soybean protein can be included in a composition in an amount of up to 90% by dry weight of the protein content. For example, a composition can have a protein content that is 10 to 95% (e.g., 45% to 95%) canola protein and 5 to 90% (e.g., 5% to 55%) soybean protein by dry weight of the protein content. In another example, in embodiments where an extruded food piece is formulated for companion animal consumption, a composition can include animal-based protein (e.g., meat or meal from chicken, beef, fish, or the like, egg, or dairy-based proteins). For example, a composition can have a protein content that is 10-95% canola protein and 5-90% animal-based protein by dry weight of the protein content.

A composition suitable for extrusion in a method provided herein includes a structural component in an amount of about 5% to about 40% (e.g., about 7% to about 30%, or about 7% to about 20%) by weight of the composition. As used herein, a structural component refers to any component of a food ingredient that is not protein and is not fat. A structural component can include, without limitation, one or more starch, fiber, sugar, gum, and the like, or any combination thereof. Examples of suitable ingredients that can contribute to a structural ingredient include grain flours (e.g., rice flour, wheat flour, oat flour, corn flour, and the like), legume flours (e.g., pea flour, soybean flour, lentil flour, and the like), starches (e.g., unmodified starch, pregelatinized starch, and the like), gums (e.g., locust bean gum, xanthan gum, and the like), and fiber ingredients (e.g., bran, inulin, cellulose, and the like). In some embodiments, a structural component can include non-fat/non-protein components in an ingredient that contributes protein to a composition. For example, if a canola protein isolate having a protein concentration of 90% by weight is used in a composition, the non-protein, non-fat components in the remaining 10% can contribute to a structural component in the composition.

A structural component can be selected, for example, in order to provide a desired nutritional profile, flavor, sweetness, and/or texture to an extruded piece. For example, oat hull fiber can be selected to produce extruded pieces having a desired fiber content, or a syrup can be selected to adjust texture and/or taste. In some embodiments, a structural component can be selected to provide a desired characteristic for an extruded piece, such as being grain-free, gluten-free, soy-free, and the like. For example, tapioca flour or starch can be selected to produce a grain-free extruded piece.

A composition suitable for extrusion in a method provided herein includes oil in an amount of from about 1% to about 15% (e.g., about 2% to about 14%, or about 5% to about 14%) by weight of the composition. Without being bound by theory, it is believed that oil contributes to the irregular expansion observed with canola protein by causing some portions of processed mass to slip more readily through a die while other portions exhibit less slip, making the processed mass appear to “slip and stick” as it exits a die described herein.

Any edible oil is suitable for use in a composition provided herein. Preferably, an oil included in a composition is liquid at room temperature. Suitable oils include, without limitation, canola oil, olive oil, soy oil, sunflower oil, corn oil, and the like. An oil to be included in a composition can be selected based on, for example, nutritional profile, compatibility with extrusion process and/or equipment, texture and/or mouthfeel imparted to an extruded piece, and/or price.

A composition suitable for extrusion in a method provided herein includes a moisture content of from about 25% to about 65% (e.g., about 30% to about 55%, or about 35% to about 45%) by weight of the composition.

In some embodiments, a composition suitable for extrusion in a method provided herein can include additional ingredients, such as inclusions (e.g., nut pieces, whole grain pieces, seeds and/or seed pieces, fruit pieces, coconut, confection pieces, and the like), flavorants (e.g., salt, fruit or vegetable powders, vanilla, cocoa, spices, or the like), colorants (e.g., fruit or vegetable juices, artificial colors, or the like), humectants (e.g., inulin, glycerol, and the like), non-nutritive sweeteners, antioxidants, vitamins, and/or minerals, and the like.

A composition suitable for extrusion in a method provided herein can be produced using any suitable method, including continuous methods and batch methods. In some embodiments, a composition is made in a continuous fashion by feeding ingredients into an extruder during an extrusion process. In some embodiments, dry ingredients can be combined to produce a dry mix prior to being combined with water and oil to produce a composition suitable for extrusion. In some embodiments, at least a portion of the moisture content in a composition can be supplied as steam.

A method provided herein includes processing a composition described herein under extrusion conditions to produce a processed mass. As used herein, the term “extrusion conditions” refers to subjecting a composition to heat, pressure, and shear in an extruder (e.g., single screw extruder, twin screw extruder, triple screw extruder, ring extruder, or the like). For example, a co-rotating, intermeshing, twin screw extruder can be used in a method provided herein. Manufacturers for co-rotating twin screw extruders include, for example, Coperion, Wenger, Clextral, Bersttorf, APV, Buhler, Thermo Scientific, and Leistritz. Manufacturers for single screw extruders include, for example, Wenger, APV, and Buhler.

Extrusion conditions can include applying sufficient mixing to distribute oil content in a composition throughout the composition. In some embodiments, extrusion conditions can comprise a die temperature of at least 100° C. (e.g., from about 120° C. to about 180° C., or from about 130° C. to about 150° C.). As used herein, the term “die temperature” refers to the maximum temperature of a composition inside a die assembly of an extruder. In some embodiments, extrusion conditions can comprise a pressure of at least about 10 bar (e.g., from about 10 bar to about 50 bar, or about 12 to about 20 bar). In some embodiments, extrusion conditions can include a specific flow rate of a processed mass through an extruder die of about 1 kg/hour/mm² to about 5 kg/hour/mm² (e.g., about 1.5 kg/hour/mm² to about 4.5 kg/hour/mm²), with the area in mm² referring to the area of the die opening. In some embodiments, each opening in a die assembly can have an area of from about 3 mm² to about 80 mm² (e.g., 5 mm² to about 80 mm²).

As discussed above, a method provided herein includes forming extruded food pieces from a processed mass using an extruder die assembly that exposes the processed mass to irregular flow prior to exiting the extruder die. An extruder die assembly can have one or multiple openings. Openings in an extruder die assembly can be any appropriate geometry, such as circular opening, a slit, or an irregular opening, and if multiple openings are included in an extruder die assembly, each opening need not have the same geometry.

In some embodiments, extruded food pieces can have average diameter of from about 2 mm to about 10 mm (e.g., from about 5 mm to about 10 mm). The size of an extruded piece can be adjusted for the desired use of the extruded piece or to provide a manufacturing advantage. For example, the size of an extruded piece can be adjusted to provide a desired size for eating as a stand-alone snack, or for use in a companion animal food. In another example, the size of an extruded piece can be adjusted to result in a desired drying time during manufacturing. Piece size can be adjusted using known methods, such as die size and/or die shape selection, rate of extrusion, and/or cutter speed.

In some embodiments, extruded food pieces can remain undried or can be partially dried. Extruded food pieces that remain undried or that are partially dried can have a similar makeup to a composition described above. Such extruded food pieces can have a relatively high specific density (e.g., at least 0.5 g/cc, or from about 0.7 g/cc to about 1.0 g/cc).

Undried or partially dried extruded food pieces can have a soft texture. Undried or partially dried extruded food pieces can be stored at refrigerated or frozen temperatures (e.g., at or below 10° C.), or packaged alone or in combination with other food components to produce food compositions that are stable for at least one month (e.g., at least 2 months) at a temperature at or below 10° C.

In some embodiments, extruded food pieces can be dried to a moisture content of less than 25% (e.g., less than 10%, about 1% to about 8%, or about 2% to about 6%) to produce dried food pieces. Drying can be performed using any suitable method and equipment. Dried food pieces can have a similar makeup to a composition described above, as adjusted on a dry weight basis, where dry weight includes all non-aqueous content. For example, a dried food piece can have a protein content of about 12% to about 90% (e.g., about 50% to about 80%) by dry weight, with at least 10% (e.g., about 25% to 100%) of the dry weight of the protein content being canola protein, a structural component content of about 6% to about 75% (e.g., about 15% to about 35%) by dry weight, and an oil content of about 1% to about 30% (e.g., about 5% to about 25%) by dry weight, with the oil distributed throughout the dried food piece.

Dried food pieces provided herein are generally not considered to puffed. Puffed pieces are typically low density (i.e., specific density of less than 0.5 g/cc, often less than 0.3 g/cc). Rather, dried food pieces provided herein can have a specific density of from 0.5 g/cc to about 1.0 g/cc (e.g., from about 0.6 g/cc to about 1.0 g/cc, or about 0.7g/cc to about 0.9 g/cc). As used herein, specific density of dried food pieces is measured by the displacement of granular sodium chloride. About 150 cc of sodium chloride is placed in a 250 ml graduated cylinder and tapped in a tap density analyzer 300×. The volume of salt is recorded to the nearest cc. The salt is then removed from the cylinder. The salt is poured back into the cylinder in about 10-20 cc aliquots alternating with pieces of a known weight of extruded pieces until the volume is approximately 150 cc. The remaining salt is then placed in the cylinder. The cylinder is again tapped 300× in the tap density analyzer. The volume is recorded and the specific density of each sample is calculated as the weight of the sample divided by the difference in tapped volume with and without sample present.

Dried food pieces can have a crunchy texture. Dried food pieces generally do not need to be stored at refrigerated or frozen temperatures. Dried food pieces can be packaged alone or in combination with other food components to produce food compositions that are stable for at least 6 months (e.g., at least 8 months, or at least a year) at a temperature of 20° C.

In some embodiments, extruded pieces (e.g., undried, partially dried, or dried food pieces) provided herein can be packaged and sold as a food product without any other components. Such packaged extruded pieces can be intended to be eaten as a food product alone or in combination with other food products. For example, extruded pieces can be packaged and sold as a stand alone snack, as part of a ready-to-eat breakfast cereal, or can be used as a topping for yogurt or oatmeal, as a bacon bit substitute, as a pet food or treat, or as a hydratable ground meat crumble substitute as part of a dry meal kit. Extruded pieces provided herein can have a texture suitable such that they need not be further prepared for eating by, for example, heating or soaking. However, in some embodiments, it is to be understood that an individual may enjoy heating and/or soaking extruded pieces provided herein during various eating occasions, such as when combined with oatmeal, when used as a ground meat substitute (e.g., in a pasta or a taco or burrito), when used in a soup, when used as a bacon bit substitute in hot foods (e.g., in a potato dish, such as mashed potatoes), or when used hydrated or partially-hydrated in a chilled or ambient temperature food, such as a pasta salad.

In some embodiments, extruded pieces provided herein can be combined with other food components to produce a food product. For example, extruded pieces can be combined with food product pieces, such as ready to eat (RTE) cereal pieces or pet kibble, to produce a food product having desired protein content. In another example, extruded pieces can be combined with dried fruit and/or nuts to produce a snack mix type product or a granola type product.

In some embodiments, extruded pieces provided herein can be packaged into a kit with other food products. For example, extruded pieces can be combined as a kit with yogurt, which can be combined prior to eating. Other examples of kits that can include the extruded pieces described herein include, without limitation, taco kits (e.g., including seasoning and/or taco shells or tortillas), pasta kits (e.g., including noodles), instant potato kits (e.g., mashed or potatoes au gratin), instant soup kits, and the like.

In some embodiments, an extruded piece can be adhered with one or more edible components, such as another extruded piece, nut pieces, fresh or dried fruit pieces, seeds, coconut, grain, and the like, to form a cluster. An extruded piece and one or more edible components can be adhered to each other using any appropriate method and ingredients (e.g., edible binders and the like). For example, a cluster can be produced using a combination of an extruded piece and rolled oats adhered using a honey-based binder or slurry. Clusters can be provided as a food product alone or as part of a food product, such as a snack mix, ready to eat cereal, or oatmeal mix.

In some embodiments, an extruded piece can be adhered with one or more edible components in a similar manner to a cluster described above, and formed into a snack or breakfast bar. Such a snack bar can be crunchy or chewy, sweet or savory.

It is to be understood that extruded pieces provided herein can be used for either sweet or savory applications in human food, or flavored as appropriate for a pet food. Extruded pieces disclosed herein can provide a benefit of being a high protein stand-alone food product or provide added protein in combination with other components in food products while also providing an improved appearance and reduced or no soy content over other known high protein pieces.

### EXAMPLES

### Example 1

Formulations including according to Table 1 (amounts are provided as a % weight of the composition) were combined in a 26 mm diameter twin screw extruder, with a length to diameter ratio of about 29 to form compositions. The compositions were processed under extrusion conditions, including a temperature of barrel temperature of about 130° C. to about 150° C., a screw speed of about 250 to about 300 rpm, a flow rate of about 12 kg/hr to about 15 kg/hr, and a specific flow rate of the processed mass through the die of about 1.5 to 4.5 kg/hr/mm². The processed mass was extruded through a single hole die having a diameter of 0.159 inches (4 mm) to form extruded ropes. The ropes were dried to a moisture content of about 1.5% to about 8% to form a dried food.

TABLE 1

| | Soybean | Canola | | | | |
|---|---|---|---|---|---|---|
| | protein | protein | Oat | | | |
| | isolate | isolate | protein | | | |
| | (90% | (90% | (55% | Rice | | Added |
| Sample | protein) | protein) | protein) | flour | Oil | water |
| Control | 52% | 0% | 0% | 17% | 3% | 28% |
| 1 | 0% | 52% | 0% | 17% | 3% | 28% |
| 2 | 0% | 0% | 52% | 17% | 3% | 28% |
| 3 | 26% | 26% | 0% | 17% | 3% | 28% |

The control, containing soybean protein exhibited minimal but irregular expansion as the processed mass exited the die. Similarly, sample 1, containing canola protein, and sample 3, containing a 50:50 canola protein and soybean protein mixture, exhibited the irregular expansion seen in the control sample. Pressure in the die reached about 25 to about 32 bar for each of these samples. Extruded ropes from samples 1 and 3 exhibited a rough surface texture similar to the rough surface texture of the control sample containing only soybean protein. Dried ropes from the control and samples 1 and 3, had a crunchy texture.

Sample 2, which contained oat protein produced extruded ropes that had a smooth surface texture. Dried ropes from sample 2 remained soft.

### Example 2

Formulations including according to Table 2 (amounts are provided as a % weight of the composition) were combined in a 42 mm diameter twin screw extruder, with a length to diameter ratio of about 29 to form compositions. The compositions were processed under extrusion conditions, including a barrel temperature of about 140° C. to about 180° C., a screw speed of about 225, a flow rate of about 34 kg/hr to about 54 kg/hr, and a specific flow rate of the processed mass through the die opening of about 2.5 to 4.5 kg/hr/mm². The processed mass was extruded through a single hole die having a diameter of 0.159 inches (4 mm) and cut to form extruded pieces approximately 5 mm to 10 mm. The pieces were dried using tray dryer to a moisture content of about 1.5% to about 8% to form extruded pieces.

TABLE 2

| | Soybean | Canola | Oat | | | |
|---|---|---|---|---|---|---|
| | protein | protein | protein | | | |
| | isolate | isolate | concen- | | | |
| | (90% | (90% | trate (55% | Rice | | Added |
| Sample | protein) | protein) | protein) | flour | Oil | water |
| Control 1 | 36.4% | 0.0% | 0.0% | 4.0% | 2.1% | 57.4% |
| Control 2 | 32.7% | 0.0% | 0.0% | 8.2% | 2.1% | 57.0% |
| Control 3 | 35.5% | 0.0% | 0.0% | 8.9% | 2.3% | 53.2% |
| Control 4 | 28.7% | 0.0% | 0.0% | 12.3% | 2.1% | 56.9% |
| Control 5 | 38.9% | 0.0% | 0.0% | 16.7% | 9.3% | 35.2% |
| Canola 1 | 0.0% | 47.3% | 0.0% | 15.8% | 2.6% | 34.2% |
| Canola 2 | 0.0% | 43.1% | 0.0% | 7.6% | 13.8% | 35.5% |
| Oat | 0.0% | 0.0% | 44.2% | 14.7% | 16.4% | 24.6% |

The control samples, containing soybean protein exhibited minimal but irregular expansion as the processed mass exited the die. Similarly, samples Canola 1 and Canola 2, containing canola protein, exhibited the irregular expansion seen in the control samples. Pressure in the die reached about 10 to about 31 bar for each of these samples. Extruded pieces from samples Canola 1 (FIG. 2, left photo) and Canola 2 (FIG. 2, right photo) exhibited a rough surface texture similar to the rough surface texture of the control samples containing only soybean protein (FIG. 1, left photo, showing Control 1). Dried pieces from the control samples and samples Canola 1 and Canola 2, had a crunchy texture.

The oat sample, which contained oat protein produced extruded pieces that had a smooth surface texture (FIG. 1, right photo). Dried pieces from sample 2 remained soft.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method of making extruded food pieces having a rough textured surface, the method comprising:
a. processing a composition under extrusion conditions to produce a processed mass, the extrusion conditions including a specific flow rate of the processed mass of about 1 to about 5 kg per hour per mm² through an extruder die assembly that exposes the processed mass to irregular flow prior to exiting one or more openings in the extruder die assembly, the composition having:
i. a protein content of about 10% to about 65% by weight of the composition, the protein content including canola protein in an amount of at least 45% by dry weight of the protein content,
ii. a structural component in an amount of from about 5% to about 40%,
iii. a moisture content of from about 25% to about 65% by weight, and
iv. an oil content of from about 1% to about 15% by weight;
b. forming the extruded food pieces from the processed mass.

2. (canceled)

3. The method of claim 1, wherein the canola protein comprises at least 95% by dry weight of the protein content.

4. (canceled)

5. The method of claim 1, wherein each of the one or more openings has area of from about 3 mm² to about 80 mm².

6. The method of claim 1, wherein the extruded food pieces have a specific density of 0.5 g/cc to about 1.0 g/cc.

7. The method of claim 1, further comprising a step of drying the extruded food pieces to a moisture content of 1-8% to produce dried food pieces.

8. The method of claim 7, wherein the dried food pieces have a specific density of about 0.5 g/cc to 1 g/cc.

9. A food composition comprising extruded food pieces made according to the method of claim 1.

10. The food composition of claim 9, wherein the food composition is formulated for human consumption.

11. The food composition of claim 9, wherein the food composition is formulated for companion animal consumption.

12. The food composition of claim 9, wherein the food composition is stable at a temperature at or below 10° C. for at least 1 month.

13. The food composition of claim 9, wherein the food composition is stable at room temperature for at least 6 months.

14. A food composition, comprising extruded food pieces, the extruded food pieces having:
a. a protein content of about 12% to about 90% by dry weight of the extruded food pieces, the protein content including canola protein in an amount of at least 45% by dry weight of the protein content;
b. a structural component in an amount of about 6% to about 75% by dry weight of the extruded food pieces,
c. an oil content of about 1% to about 30% by dry weight of the extruded food pieces; and
d. a rough textured surface.

15. (canceled)

16. The food composition of claim 14, wherein the canola protein comprises at least 95% by dry weight of the protein content.

17. The food composition of claim 14, wherein the food composition is formulated for human consumption.

18. The food composition of claim 14, wherein the food composition is formulated for companion animal consumption.

19. A packaged food product, comprising the food composition of claim 14.
